(19) United States
(12) Patent Application Publication
(10) Pub. No.: US 2022/0357587 A1
(43) Pub. Date: Nov. 10, 2022

(54) ACTUATION DEVICE AND CAMERA DEVICE

(71) Applicant: Changzhou AAC Raytech Optronics Co., Ltd., Changzhou City (CN)

(72) Inventors: Wesley Chang, Shenzhen (CN); Manson Su, Shenzhen (CN); Ryan Lee, Shenzhen (CN)

(21) Appl. No.: 17/566,731

(22) Filed: Dec. 31, 2021

(30) Foreign Application Priority Data
May 7, 2021 (CN) 202110493784.6

(51) Int. Cl. G02B 27/64; G03B 5/00; H04N 5/225

(52) U.S. Cl. CPC G02B 27/646; G03B 5/00; H04N 5/2254; G03B 2205/0076

(57) ABSTRACT

An actuation device and a camera device are provided. The actuation device includes a fixation base including a first bottom plate, a rotation base including a second bottom plate, a spindle assembly between the first bottom plate and the second bottom plate, a driving mechanism including two SMA wires connected to two suspension portions in a one-to-one correspondence, and a PCB connected to the driving mechanism. A first avoiding opening is provided on the first bottom plate. The two suspension portions extending toward the first avoiding opening is provided on the second bottom plate. Each SMA wire is connected to one suspension portion and a side of the first bottom plate. Two shape memory alloy wires drive the rotation base to rotate counterclockwise and clockwise around the central axis, respectively. The SMA wires can control the rotation base to rotate around the optical axis of the camera lens.

### TECHNICAL FIELD

The present invention relates to the field of optical imaging technologies, and in particular, to an actuation device and a camera device.

### BACKGROUND

In the field of optical image stabilization (OIS) for a lens, the lens is generally driven by the shape memory alloy (SMA) wire. In the related art, the SMA wire generally moves in X and Y directions that are perpendicular to an optical axis of the lens.

### SUMMARY

An objective of the present invention is to provide an actuation device and a camera device, which utilizes two U-shaped SMA wires to drive a lens to rotate around an optical axis.

A first aspect of the present invention provides an actuation device. The actuation device includes a fixation base, a rotation base mounted on the fixation base, a spindle assembly sandwiched between the fixation base and the rotation base, a driving mechanism arranged at a side of the fixation base facing away from the rotation base and configured to drive the rotation base to rotate, and a printed circuit board connected to the driving mechanism. The fixation base includes a first bottom plate and a first enclosure wall surrounding the first bottom plate, the rotation base includes a second bottom plate and a second enclosure wall surrounding the second bottom plate, the spindle assembly is sandwiched between the first bottom plate and the second bottom plate, a first avoiding opening is provided in the first bottom plate, and two suspension portions each extending toward the first avoiding opening are provided on the second bottom plate. The driving mechanism includes two shape memory alloy wires connected to the two suspension portions in a one-to-one correspondence. The two shape memory alloy wires are connected to the two suspension portions, respectively, and are connected to a side of the first bottom plate facing away from the second bottom plate. A central axis of the spindle assembly is perpendicular to the first bottom plate. One of the two shape memory alloy wires drives the rotation base to rotate counterclockwise around the central axis, and the other one of the two shape memory alloy wires drives the rotation base to rotate clockwise around the central axis.

As an improvement, each of the two shape memory alloy wires includes two end portions fixed to the first bottom plate, and a middle portion located between the two end portions. The middle portion is suspended on one of the two suspension portions.

As an improvement, the driving mechanism further includes two wire-binding clamp pairs that are in a one-to-one correspondence with the two shape memory alloy wires. Each of the two wire-binding clamp pairs includes two wire-binding clamps that are in a one-to-one correspondence with the two ends of one of the two shape memory alloy wires. Each of the two wire-binding clamps is disposed on the first bottom plate, and has one side connected to one of the two end portions of one of the two shape memory alloy wires, and another side electrically connected to the printed circuit board provided on a side of the first bottom plate facing away from the rotation base.

As an improvement, the two suspension portions are symmetrically arranged with respect to a first symmetry axis, and the two wire-binding clamp pairs are arranged at two sides of the first symmetry axis, respectively. The two shape memory alloy wires are arranged at two sides of the first symmetry axis, respectively, and include one shape memory alloy wire inclined to a first side of the first symmetry axis and another shape memory alloy wire inclined to another side opposite to the first side of the first symmetry axis.

As an improvement, the spindle assembly includes four spheres sandwiched between the first bottom plate and the second bottom plate, wherein the four spheres are uniformly and equally distributed on a periphery of a circle, and the central axis penetrates through a center of the circle.

As an improvement, a plurality of first limiting blocks each extending toward the second bottom plate is provided on the first bottom plate. Each of the plurality of the first limiting blocks includes an arc-shaped periphery, peripheries of the plurality of the first limiting blocks define a circle on which four limiting grooves are uniformly distributed, and the four limiting grooves are recessed from the arc-shaped peripheries to the center of the circle, respectively. The four spheres are arranged in a one-to-one correspondence with the four limiting grooves and are accommodated in the four limiting grooves, respectively. A plurality of second limiting blocks each extending toward the first bottom plate is provided on the second bottom plate, and has arc-shaped peripheries abutting against and enclosing the four limiting grooves.

As an improvement, the first enclosure walls respectively have openings that are arranged symmetrically, and each of the first enclosure walls is opposite to one of the second enclosure walls. A boss extending toward one opening of the openings is provided on each of the second enclosure walls, penetrates through the one opening, and is moved within the one opening.

As an improvement, a plurality of limiting posts each extending toward the first enclosure wall is provided on the second enclosure wall, an extension length of one of the plurality of limiting posts is smaller than an extension length of one of the bosses of the second enclosure walls, and a plurality of the limiting blocks is distributed at two sides of one of the bosses.

As an improvement, a second avoiding opening is provided in the first bottom plate, a third avoiding opening opposite to the second avoiding opening is provided in the second bottom plate, the second avoiding opening accommodates a first magnet, the third avoiding opening accommodates a second magnet, and the first magnet and the second magnet attract each other; and/or, an accommodating groove is provided at a side of the second bottom plate facing towards the first bottom plate and is configured to receive a third magnet, a fourth avoiding opening is provided in the first bottom plate, a Hall sensor is provided in the fourth avoiding opening and is arranged corresponding to the accommodating groove, and the third magnet is configured to cooperate with the Hall sensor to detect a displacement deviation.

A second aspect of the present invention provides a camera device. The camera device comprises an actuation device and an optical lens module. The actuation device includes a fixation base, a rotation base mounted on the fixation base, a spindle assembly sandwiched between the fixation base and the rotation base, a driving mechanism arranged on a side of fixation base facing away from the rotation base and configured to drive the rotation base to rotate, and a printed circuit board connected to the driving mechanism. The optical lens module is mounted on the rotation base of the actuation device and has an optical axis coinciding with a central axis of the actuation device. The fixation base includes a first bottom plate and a first enclosure wall surrounding the first bottom plate, the rotation base includes a second bottom plate and a second enclosure wall surrounding the second bottom plate, the spindle assembly is sandwiched between the first bottom plate and the second bottom plate, a first avoiding opening is provided in the first bottom plate, and two suspension portions each extending toward the first avoiding opening are provided on the second bottom plate. The driving mechanism includes two shape memory alloy wires connected to the two suspension portions in a one-to-one correspondence. The two shape memory alloy wires are connected to the two suspension portions, respectively, and are connected to a side of the first bottom plate facing away from the second bottom plate. A central axis of the spindle assembly is perpendicular to the first bottom plate. One of the two shape memory alloy wires drives the rotation base to rotate counterclockwise around the central axis, and the other one of the two shape memory alloy wires drives the rotation base to rotate clockwise around the central axis.

As an improvement, each of the two shape memory alloy wires includes two end portions fixed to the first bottom plate, and a middle portion located between the two end portions. The middle portion is suspended on one of the two suspension portions.

As an improvement, the driving mechanism further includes two wire-binding clamp pairs that are in a one-to-one correspondence with the two shape memory alloy wires. Each of the two wire-binding clamp pairs includes two wire-binding clamps that are in a one-to-one correspondence with the two ends of one of the two shape memory alloy wires. Each of the two wire-binding clamps is disposed on the first bottom plate, and has one side connected to one of the two end portions of one of the two shape memory alloy wires, and another side electrically connected to the printed circuit board provided on a side of the first bottom plate facing away from the rotation base.

As an improvement, the two suspension portions are symmetrically arranged with respect to a first symmetry axis, and the two wire-binding clamp pairs are arranged at two sides of the first symmetry axis, respectively. The two shape memory alloy wires are arranged at two sides of the first symmetry axis, respectively, and include one shape memory alloy wire inclined to a first side of the first symmetry axis and another shape memory alloy wire inclined to another side opposite to the first side of the first symmetry axis.

As an improvement, the spindle assembly includes four spheres sandwiched between the first bottom plate and the second bottom plate, wherein the four spheres are uniformly and equally distributed on a periphery of a circle, and the central axis of the spindle assembly penetrates through a center of the circle.

As an improvement, a plurality of first limiting blocks each extending toward the second bottom plate is provided on the first bottom plate. Each of the plurality of the first limiting blocks includes an arc-shaped periphery, peripheries of the plurality of the first limiting blocks define a circle on which four limiting grooves are uniformly distributed, and the four limiting grooves are recessed from the arc-shaped peripheries to the center of the circle, respectively. The four spheres are arranged in a one-to-one correspondence with the four limiting grooves and are accommodated in the four limiting grooves, respectively. A plurality of second limiting blocks each extending toward the first bottom plate is provided on the second bottom plate, and has arc-shaped peripheries abutting against and enclosing the four limiting grooves.

As an improvement, the first enclosure walls respectively have openings that are arranged symmetrically, and each of the first enclosure walls is opposite to one of the second enclosure walls. A boss extending toward one opening of the openings is provided on each of the second enclosure walls, penetrates through the one opening, and is moved within the one opening.

As an improvement, a plurality of limiting posts each extending toward the first enclosure wall is provided on the second enclosure wall, an extension length of one of the plurality of limiting posts is smaller than an extension length of one of the bosses of the second enclosure walls, and a plurality of the limiting blocks is distributed at two sides of one of the bosses.

As an improvement, a second avoiding opening is provided in the first bottom plate, a third avoiding opening opposite to the second avoiding opening is provided in the second bottom plate, the second avoiding opening accommodates a first magnet, the third avoiding opening accommodates a second magnet, and the first magnet and the second magnet attract each other; and/or, an accommodating groove is provided at a side of the second bottom plate facing towards the first bottom plate and is configured to receive a third magnet, a fourth avoiding opening is provided in the first bottom plate, a Hall sensor is provided in the fourth avoiding opening and is arranged corresponding to the accommodating groove, and the third magnet is configured to cooperate with the Hall sensor to detect a displacement deviation.

In the provided actuation device and the camera device, the actuation device includes a fixation base, a rotation base mounted on the fixation base, a spindle assembly sandwiched between the fixation base and the rotation base, a driving mechanism, a driving mechanism arranged on a side of the fixation base facing away from the rotation base and configured to drive the rotation base to rotate, and a printed circuit board connected to the driving mechanism. The fixation base includes a first bottom plate and a first enclosure wall surrounding the first bottom plate, the rotation base includes a second bottom plate and a second enclosure wall surrounding the second bottom plate, the spindle assembly is sandwiched between the first bottom plate and the second bottom plate, a first avoiding opening is provided in the first bottom plate, and two suspension portions each extending toward the first avoiding opening are provided on the second bottom plate. The driving mechanism includes two shape memory alloy wires connected to the two suspension portions in a one-to-one correspondence, and the two shape memory alloy wires are connected to the two suspension portions, respectively, and are connected to a side of the first bottom plate facing away from the second bottom plate. A central axis of the spindle assembly is perpendicular to the first bottom plate. One of the two shape memory alloy wires drives the rotation base to rotate counterclockwise around the central axis, and the other one of the two shape memory alloy wires drives the rotation base to rotate clockwise around the central axis. The SMA wires can control the rotation base to rotate around the optical axis of the lens.

### BRIEF DESCRIPTION OF DRAWINGS

FIG. 1 is a schematic diagram showing an actuation device according to an embodiment of the present invention;

FIG. 2 is an exploded view of the actuation device shown in FIG. 1 at a first view angle according to an embodiment of the present invention;

FIG. 3 is an exploded view of the actuation device shown in FIG. 2 at a view angle opposite to the first view angle according to an embodiment of the present invention;

FIG. 4 is a schematic diagram showing a backside of an actuation device after a rotation base and a fixation base are assembled according to an embodiment of the present invention;

FIG. 5 is a schematic diagram showing a camera device according to an embodiment of the present invention; and

FIG. 6 is an exploded view showing the camera device of FIG. 5 according to an embodiment of the present invention.

### DESCRIPTION OF REFERENCE NUMERALS

100: actuation device; 1: fixation base; 11: first bottom plate; 12: first enclosure wall; 13: first avoiding opening; 14: first limiting block; 15: limiting groove; 16: opening; 17: second avoiding opening; 18: first magnet; 19: fourth avoiding opening; 2: rotation base; 21: second bottom plate; 22: second enclosure wall; 23: suspension portion; 24: second limiting block; 25: boss; 26: limiting post; 27: third avoiding opening; 28: second magnet; 29: accommodating groove; 3: sphere; 4: driving mechanism; 41: shape memory alloy wire; 42: wire-binding clamp; 5: printed circuit board; 6: third magnet; 7: Hall sensor; 200: camera device; 210: optical lens module; 01: optical axis; 02: central axis; 03: first symmetry axis.

### DESCRIPTION OF EMBODIMENTS

The present invention will be further described below in conjunction with the drawings and embodiments.

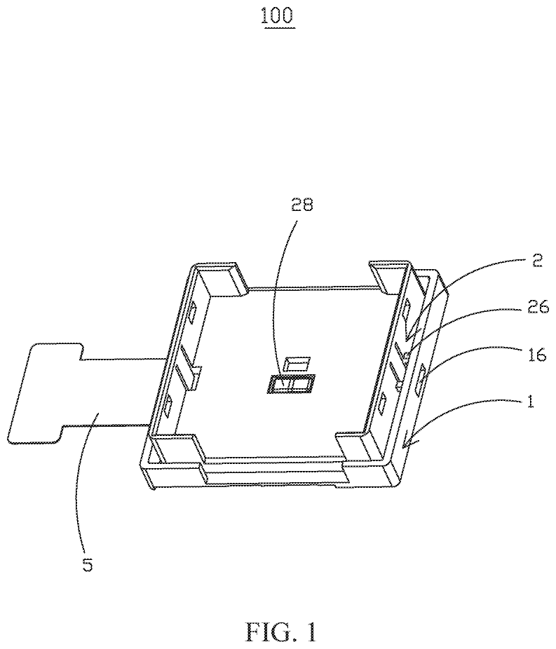

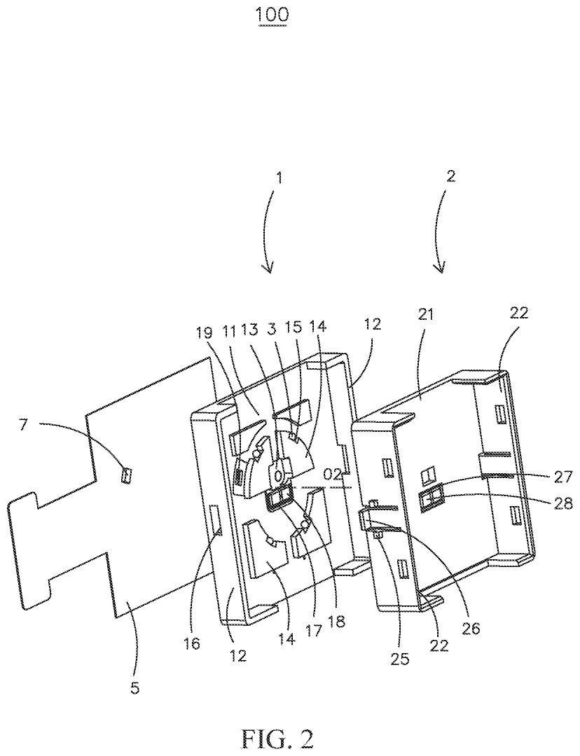

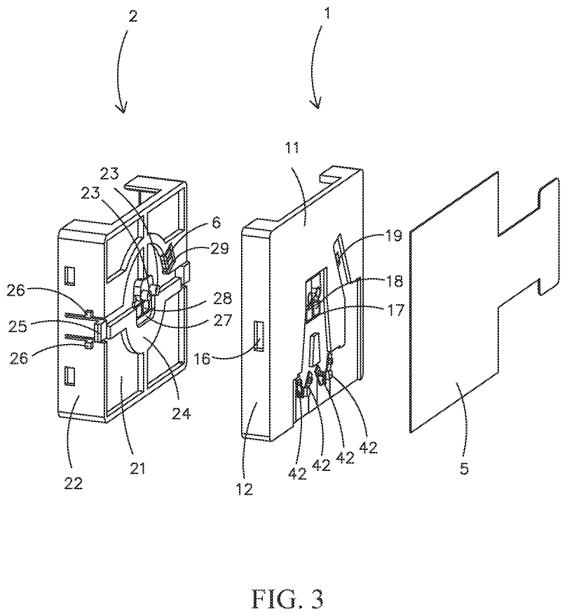

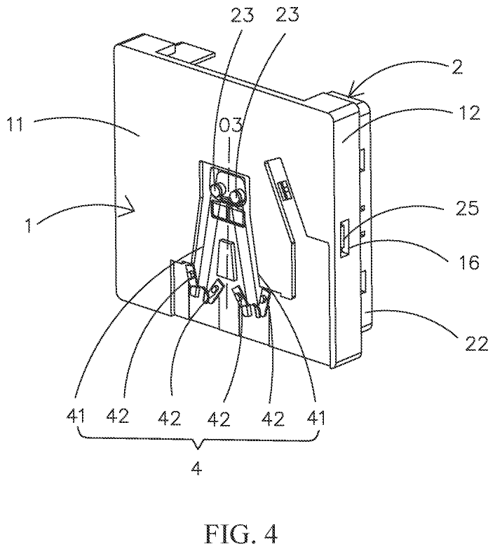

Referring to FIG. 1 to FIG. 4, an embodiment of the present invention provides an actuation device 100. The actuation device 100 includes a fixation base 1, a rotation base 2, a spindle assembly, a driving mechanism 4, and a printed circuit board 5. The rotation base 2 is rotatably mounted on the fixation base 1. The spindle assembly is sandwiched between the fixation base 1 and the rotation base 2. The driving mechanism 4 is arranged on the fixation base 1 and is connected to the rotation base 2. The printed circuit board 5 is connected to the driving mechanism 4. The driving mechanism 4 drives the rotation base 2 connected to the driving mechanism 4. The rotation base 2 is rotated on the fixation base 1 through the spindle assembly.

The fixation base 1 includes a first bottom plate 11 and a first enclosure wall 12. The first enclosure wall 12 extends from an edge of the first bottom plate 11 towards a direction away from the first bottom plate 11. The first bottom plate 11 is rectangular. The first enclosure wall 12 is symmetrically arranged at two opposite sides of the first bottom plate 11. The rotation base 2 includes a second bottom plate 21 and a second enclosure wall 22. The second enclosure wall 22 extends from an edge of the second bottom plate 21 towards a direction away from the second bottom plate 21. The second bottom plate 21 is rectangular. The second enclosure wall 22 is symmetrically arranged at two opposite sides of the second bottom plate 21. The second enclosure wall 22 is opposite to the first enclosure wall 12. The first enclosure wall 12 is arranged outside the second enclosure wall 22 and spaced apart from the second enclosure wall 22. The second bottom plate 21 is arranged on the first bottom plate 11. A first avoiding opening 13 is provided in the first bottom plate 11. The first avoiding opening 13 penetrates through the first bottom plate 11. Two suspension portions 23 each extending toward the first bottom plate 11 are provided on the second bottom plate 21. The two suspension portions 23 extend out from the first avoiding opening 13, and are cylinders. In an embodiment of the present invention, the first bottom plate 11 is parallel to the second bottom plate 21.

The driving mechanism 4 includes two shape memory alloy wires 41 which are in a one-to-one correspondence with the two suspension portions 23. Each shape memory alloy wire 41 is connected to a corresponding suspension portion 23 and a side of the first bottom plate 11 facing away from the second bottom plate 21. A central axis 02 of the spindle assembly is perpendicular to the first bottom plate 11. One of the two shape memory alloy wires 41 drives the rotation base 2 to rotate counterclockwise around the central axis 02, and the other one of the two shape memory alloy wires 41 drives the rotation base 2 to rotate clockwise around the central axis 02. In an embodiment of the present invention, each shape memory alloy wire 41 includes two end portions and a middle portion provided between the two end portions. The two end portions are fixed to the side of the first bottom plate 11 facing away from the second bottom plate 21, and the middle portion is suspended on the suspension portion 23. A part of the shape memory alloy wire 41 between one of the two ends and a corresponding suspension portion 23 is parallel to another part of the shape memory alloy wire 41 between the other one of the two ends and this corresponding suspension portion 23. The central axis 02 of the spindle assembly is perpendicular to the first bottom plate 11. One of the two shape memory alloy wires 41 drives the rotation base 2 to rotate counterclockwise around the central axis 02, and the other one of the two shape memory alloy wires 41 drives the rotation base 2 to rotate clockwise around the central axis 02. The rotation base 2 is controlled to rotate clockwise and counterclockwise around the central axis 02 by the two shape memory alloy wires 41. In an embodiment of the present invention, each of the two shape memory alloy wires 41 forms a U shape.

In the actuation device 100 of the present invention, when the current is supplied to two SMA wires, the SMA wire is shrunken after the temperature of the first SMA wire increases, so that the t SMA wire suspended on the suspension portion 23 is driven to rotate, and the rotation base 2 is driven by the spindle assembly to rotate on the first bottom plate 11. By turning on and turning off of the two SMA wires, an angle at which the rotation base 2 rotates around the central axis of the spindle assembly perpendicular to the first bottom plate 11 can be adjusted. The actuation device 100 of the present invention has a compact structure, thereby reducing the volume of the actuation device 100.

In an embodiment of the present invention, the driving mechanism 4 further includes two wire-binding clamp pairs which are in a one-to-one correspondence with the two shape memory alloy wires 41. The two wire-binding clamp pairs are fixedly provided on the side of the first bottom plate 11 facing away from the second bottom plate 21. Each of the wire-binding clamp pairs includes two wire-binding clamps 42. The wire-binding clamps 42 are connected to two ends of a corresponding shape memory alloy wire 41 in a one-to-one correspondence. Each wire-binding clamp 42 is electrically connected to the printed circuit board 5 provided on the side of the first bottom plate 11 facing away from the rotation base 2. In an embodiment of the present invention, the two suspension portions 23 are arranged symmetrically with respect to a first symmetry axis 03. Two wire-binding clamp pairs are arranged at two sides of the first symmetry axis 03, respectively. Two shape memory alloy wires 41 are distributed at two sides of the first symmetry axis, respectively, one of the two shape memory alloy wires 41 is inclined to a left side of the first symmetry axis 03, and the other one of the two shape memory alloy wires 41 is inclined to a right side of the first symmetry axis 03. In an embodiment of the present invention, the two wire-binding clamp pairs are arranged symmetrically with respect to the first symmetry axis 03, and the two shape memory alloy wires 41 are also arranged symmetrically with respect to the first symmetry axis 03.

In an embodiment of the present invention, the spindle assembly includes four spheres 3 sandwiched between the first bottom plate 11 and the second bottom plate 21. The four spheres 3 are arranged on a circumference of a same circle and are equally spaced. The central axis 02 penetrates through a center of the circle where the four spheres 3 are located, and is perpendicular to the first bottom plate 11 and the second bottom plate 12.

In an embodiment of the present invention, a plurality of first limiting blocks 14 each extending toward the second bottom plate 21 is provided on the first bottom plate 11. The shapes of the plurality of first limiting blocks 14 can be the same or different, as long as each of the plurality of the first limiting blocks 14 has an arc-shaped periphery. The arc-shaped peripheries of the plurality of the first limiting blocks 14 enclose to form a circle on which four limiting grooves 15 are uniformly distributed, and the limiting groove 15 is recessed from the arc-shaped periphery to the center of the circle. The limiting groove 15 is arc-shaped. The spheres 3 are in a one-to-one correspondence with the limiting grooves 15 and are accommodated in the limiting grooves 15. During the rotation of the rotation base 2, the four spheres 3 can roll in the limiting groove 15 along the arc-shaped periphery. In an embodiment of the present invention, the shapes of the four limiting grooves 15 are completely the same. In an embodiment of the present invention, a plurality of second limiting blocks 24 each extending toward the first bottom plate 11 is provided on the second bottom plate 21. The arc-shaped peripheries of the plurality of second limiting blocks 24 abut against and close notches of the limiting grooves 15. The sphere 3 is confined within the limiting groove 15 to prevent the ball 3 from rolling out of the limiting groove 15 during the rolling process.

In an embodiment of the present invention, openings 16 that are symmetrical to each other are provided in the opposite first enclosure walls 12, respectively, and a boss 25 extending toward the opening 16 is provided on second enclosure wall 22. The boss 25 penetrates through the opening 16 and moves within the opening 16. The opening 16 cooperates with the boss 25 to limit the rotation of the rotation base 2 so that the rotation base 2 rotates on the fixation base 1 around a rotation axis parallel to the first bottom plate 11.

In an embodiment of the present invention, a plurality of limiting posts 26 each extending toward the first enclosure wall 12 is provided on the second enclosure wall 22. An extension length of the limiting post 26 is smaller than an extension length of the boss 25. A plurality of the limiting blocks is distributed at two sides of the boss 25. In this way, an area in which the second bottom plate 21 rotates on the first bottom plate 11 during the rotation of the rotation base 2 in the fixation base 1 is limited, and it is avoid that the second enclosure wall 22 directly collides the first enclosure wall 12.

In an embodiment of the present invention, a second avoiding opening 17 is provided in the first bottom plate 11, and a third avoiding opening 27 is provided in the second bottom plate 21. When the second bottom plate 21 is provided on the first bottom plate 11, the second avoiding opening 17 is directly opposite to the third avoiding opening 27. A first magnet 18 is accommodated in the second avoiding opening 17, and a second magnet 28 is accommodated in the third avoiding opening 27. The first magnet 18 and the second magnet 28 attract each other. The first magnet 18 and the second magnet 28 that attract each other are arranged on the first bottom plate 11 and the second bottom plate 21, respectively, to avoid the deviation of the distance between the fixation base 1 and the rotation base 2 in the vertical rotation direction.

In an embodiment of the present invention, the actuation device 100 further includes a third magnet 6 and a Hall sensor 7 that is configured to cooperate with the third magnet. The first bottom plate 11 is provided with a fourth avoiding opening 19 penetrating through the first bottom plate 11 and configured to accommodate the Hall sensor 7. An accommodating groove 29 is provided on a side of the second bottom plate 21 facing towards the first bottom plate 11, and is configured to receive the third magnet 6. The accommodating groove 29 corresponds to the fourth avoiding opening 19, so that the Hall sensor 7 and the third magnet 6 are spaced apart and directly opposed to each other. The third magnet 6 can be used to cooperate with the Hall sensor 7 to detect a displacement deviation between the fixation base 1 and the rotation base 2. In an embodiment of the present invention, the Hall sensor 7 is provided on the printed circuit board 5.

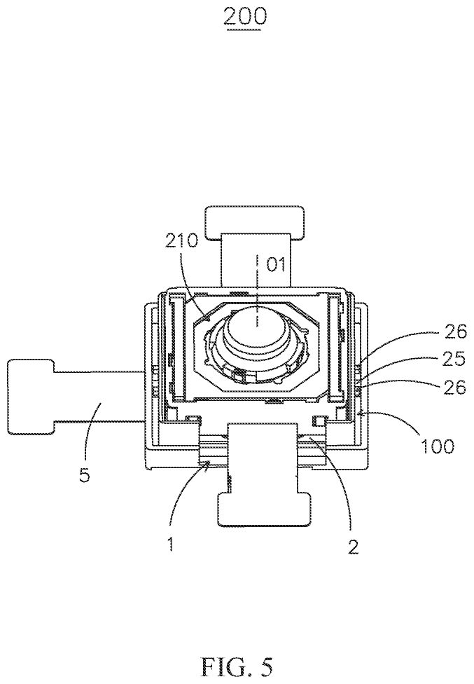

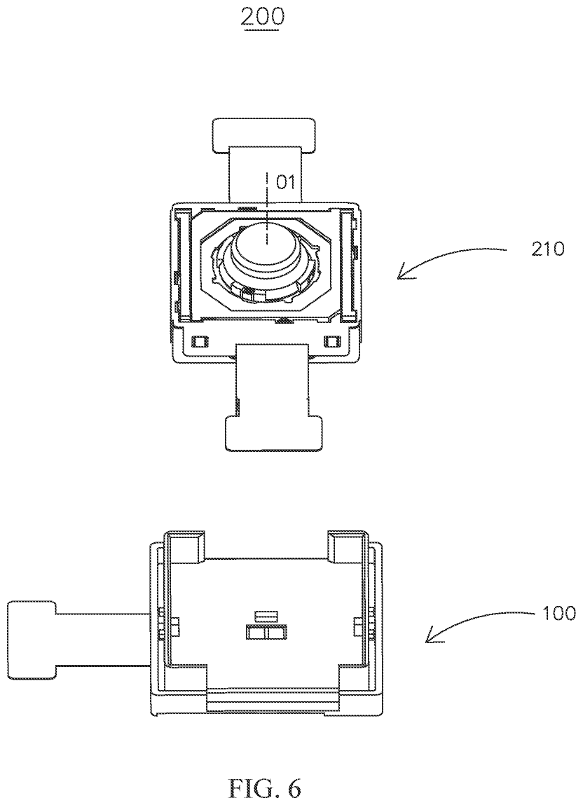

Referring to FIG. 5 and FIG. 6, the present invention also provides a camera device 200. The camera device 200 includes the above actuation device 100 and an optical lens module 210. The optical lens module 210 is mounted on the rotation base 2 of the actuation device 100. An optical axis 01 of the optical lens module 210 coincides with a central axis 02 of the actuation device 100. The actuation device 100 drives an optical lens module 210 to rotate around the optical axis 01 on a plane perpendicular to the optical axis 01. The optical lens module 210 can achieve autofocus and optical image stabilization functions of the lens.

The above are merely some embodiments of the present invention. It should be noted that for those skilled in the art, modifications can be made without departing from the inventive concept of the present invention, but these all fall into the protection scope of the present invention.

What is claimed is:

1. An actuation device, comprising:
a fixation base;
a rotation base mounted on the fixation base;
a spindle assembly sandwiched between the fixation base and the rotation base;
a driving mechanism arranged on a side of the fixation base facing away from the rotation base and configured to drive the rotation base to rotate; and
a printed circuit board connected to the driving mechanism,
wherein the fixation base comprises a first bottom plate and a first enclosure wall surrounding the first bottom plate, the rotation base comprises a second bottom plate and a second enclosure wall surrounding the second bottom plate, the spindle assembly is sandwiched between the first bottom plate and the second bottom plate, a first avoiding opening is provided in the first bottom plate, and two suspension portions each extending toward the first avoiding opening are provided on the second bottom plate; and
the driving mechanism comprises two shape memory alloy wires connected to the two suspension portions in a one-to-one correspondence, wherein the two shape memory alloy wires are connected to the two suspension portions, respectively, and are connected to a side of the first bottom plate facing away from the second bottom plate; a central axis of the spindle assembly is perpendicular to the first bottom plate; and one of the two shape memory alloy wires drives the rotation base to rotate counterclockwise around the central axis, and the other one of the two shape memory alloy wires drives the rotation base to rotate clockwise around the central axis.

2. The actuation device as described in claim 1, wherein each of the two shape memory alloy wires comprises two end portions fixed to the first bottom plate, and a middle portion located between the two end portions, wherein the middle portion is suspended on one of the two suspension portions.

3. The actuation device as described in claim 2, wherein the driving mechanism further comprises two wire-binding clamp pairs that are in a one-to-one correspondence with the two shape memory alloy wires, wherein each of the two wire-binding clamp pairs comprises two wire-binding clamps that are in a one-to-one correspondence with the two ends of one of the two shape memory alloy wires; and each of the two wire-binding clamps is disposed on the first bottom plate, and has one side connected to one of the two end portions of one of the two shape memory alloy wires and another side electrically connected to the printed circuit board provided on a side of the first bottom plate facing away from the rotation base.

4. The actuation device as described in claim 3, wherein the two suspension portions are symmetrically arranged with respect to a first symmetry axis, and the two wire-binding clamp pairs are arranged at two sides of the first symmetry axis, respectively; and
wherein the two shape memory alloy wires are arranged at two sides of the first symmetry axis, respectively, and include one shape memory alloy wire inclined to a first side of the first symmetry axis and another shape memory alloy wire inclined to another side opposite to the first side of the first symmetry axis.

5. The actuation device as described in claim 1, wherein the spindle assembly comprises four spheres sandwiched between the first bottom plate and the second bottom plate, wherein the four spheres are uniformly and equally distributed on a periphery of a circle, and the central axis penetrates through a center of the circle.

6. The actuation device as described in claim 5, wherein a plurality of first limiting blocks each extending toward the second bottom plate is provided on the first bottom plate, and each of the plurality of the first limiting blocks comprises an arc-shaped periphery, peripheries of the plurality of the first limiting blocks define a circle on which four limiting grooves are uniformly distributed, the four limiting grooves are recessed from the arc-shaped peripheries to the center of the circle, respectively, the four spheres are arranged in a one-to-one correspondence with the four limiting grooves and are accommodated in the four limiting grooves, respectively; and
a plurality of second limiting blocks each extending toward the first bottom plate is provided on the second bottom plate, and has arc-shaped peripheries abutting against and enclosing the four limiting grooves.

7. The actuation device as described in claim 5, wherein the first enclosure walls respectively have openings that are arranged symmetrically, each of the first enclosure walls is opposite to one of the second enclosure walls, and a boss extending toward one opening of the openings is provided on each of the second enclosure walls, penetrates through the one opening, and is moved within the one opening.

8. The actuation device as described in claim 7, wherein a plurality of limiting posts each extending toward the first enclosure wall is provided on the second enclosure wall, an extension length of one of the plurality of limiting posts is smaller than an extension length of one of the bosses of the second enclosure walls, and a plurality of the limiting blocks is distributed at two sides of one of the bosses.

9. The actuation device as described in claim 1, wherein a second avoiding opening is provided in the first bottom plate, and a third avoiding opening opposite to the second avoiding opening is provided in the second bottom plate, wherein the second avoiding opening accommodates a first magnet, the third avoiding opening accommodates a second magnet, and the first magnet and the second magnet attract each other; and/or
an accommodating groove is provided at a side of the second bottom plate facing toward the first bottom plate and is configured to receive a third magnet, a fourth avoiding opening is provided in the first bottom plate, a Hall sensor is provided in the fourth avoiding opening and is arranged corresponding to the accommodating groove, and the third magnet is configured to cooperate with the Hall sensor to detect a displacement deviation.

10. A camera device, comprising:
an actuation device, wherein the actuation device comprises a fixation base, a rotation base mounted on the fixation base, a spindle assembly sandwiched between the fixation base and the rotation base, a driving mechanism arranged on a side of fixation base facing away from the rotation base and configured to drive the rotation base to rotate, and a printed circuit board connected to the driving mechanism; and
an optical lens module mounted on the rotation base of the actuation device and having an optical axis coinciding with a central axis of the actuation device,
wherein the fixation base comprises a first bottom plate and a first enclosure wall surrounding the first bottom plate, the rotation base comprises a second bottom plate and a second enclosure wall surrounding the second bottom plate, the spindle assembly is sandwiched between the first bottom plate and the second bottom plate, a first avoiding opening is provided in the first bottom plate, and two suspension portions each extending toward the first avoiding opening are provided on the second bottom plate; and
the driving mechanism comprises two shape memory alloy wires connected to the two suspension portions in a one-to-one correspondence, wherein the two shape memory alloy wires are connected to the two suspension portions, respectively, and are connected to a side of the first bottom plate facing away from the second bottom plate; a central axis of the spindle assembly is perpendicular to the first bottom plate; and one of the two shape memory alloy wires drives the rotation base to rotate counterclockwise around the central axis of the spindle assembly, and the other one of the two shape memory alloy wires drives the rotation base to rotate clockwise around the central axis of the spindle assembly.
